(19) United States
(12) Patent Application Publication
(10) Pub. No.: US 2026/0162629 A1
(43) Pub. Date: Jun. 11, 2026

(54) SERVER AND CONTROL METHOD THEREOF

(71) Applicant: SAMSUNG ELECTRONICS CO., LTD., Suwon-si (KR)

(72) Inventors: Minjung KIM, Suwon-si (KR); Namkyun BEON, Suwon-si (KR); Yongmo CHOI, Suwon-si (KR)

(73) Assignee: SAMSUNG ELECTRONICS CO., LTD., Suwon-si (KR)

(21) Appl. No.: 19/178,042

(22) Filed: Apr. 14, 2025

Related U.S. Application Data
(63) Continuation of application No. PCT/KR2025/095170, filed on Apr. 7, 2025.

(30) Foreign Application Priority Data
May 31, 2024 (KR) 10-2024-0072027

(51) Int. Cl. G09G 5/10

(52) U.S. Cl. CPC G09G 5/10; G09G 2320/0233; G09G 2320/0626; G09G 2360/145

(57) ABSTRACT

A server including: a communication device configured to receive, from a measuring device, measurement data for a brightness of each of a plurality of display modules included in a display device; a memory storing the measurement data; and at least one processor configured to: calibrate first correction data with respect to a non-uniformity of a brightness of the measuring device based on the measurement data; and calibrate second correction data for each of the plurality of display modules with respect to a non-uniformity of the brightness of each of the plurality of display modules, based on the measurement data and the first correction data.

### CROSS-REFERENCE TO RELATED APPLICATIONS

This application is a continuation application of International Application No. PCT/KR2025/095170, filed on Apr. 7, 2025, in the Korean Intellectual Property Receiving Office, which claims priority to Korean Patent Application No. 10-2024-0072027, filed on May 31, 2024, in the Korean Intellectual Property Office, the disclosures of which are incorporated by reference herein in their entireties.

### BACKGROUND

### 1. Field

The present disclosure relates to a server for improving brightness non-uniformity of a display device, and a control method thereof.

### 2. Description of Related Art

In general, a display device is a kind of an output apparatus for converting obtained or stored electrical information into visual information and displaying the visual information to users. The display apparatus is used in various fields, such as homes, workplaces, etc.

Display devices are classified into self-emissive displays in which pixels emit light, and non-emissive displays using separate light sources.

As the types of display devices become more diverse and the types of content also become more diverse accordingly, importance of brightness uniformity of the display devices is increasing.

In order to improve brightness non-uniformity, a measuring device that measures a display device is used. However, due to errors of the measuring device itself, the brightness of the display device may not be uniformly set.

### SUMMARY

An aspect of the disclosure provides a server capable of improving brightness non-uniformity of a display device by calibrating correction data with respect to non-uniformity of measured brightness due to an error, etc. of a measuring device and correcting the brightness non-uniformity of the display device based on the correction data, and a control method thereof.

According to an aspect of the disclosure, a server includes: a communication device configured to receive, from a measuring device, measurement data for a brightness of each of a plurality of display modules included in a display device; a memory storing the measurement data; and at least one processor configured to: calibrate first correction data with respect to a non-uniformity of a brightness of the measuring device based on the measurement data; and calibrate second correction data for each of the plurality of display modules with respect to a non-uniformity of the brightness of each of the plurality of display modules, based on the measurement data and the first correction data.

The communication device may be configured to transmit the second correction data to each of the plurality of display modules such that the second correction data is applied to each of the plurality of display modules.

The measurement data may include a plurality of pieces of measurement data for the brightness of each of the plurality of display modules included in the display device, and the at least one processor may be further configured to calibrate the first correction data based on the plurality of pieces of measurement data.

The at least one processor may be further configured to calibrate the first correction data based on the measurement data for the brightness of each of the plurality of display modules.

The measuring device may include a plurality of measuring devices, and the at least one processor may be further configured to calibrate third correction data for each of the plurality of measuring devices with respect to the non-uniformity of the brightness of each of the plurality of measuring devices, based on the measurement data of each of the plurality of measuring devices.

The measurement data may include brightness data for each of at least one color displayed by each of the plurality of display modules.

The measurement data may include brightness data for at least one pattern displayed by each of the plurality of display modules.

According to another aspect of the disclosure, a control method of a server includes: receiving, from a measuring device, measurement data for a brightness of each of a plurality of display modules included in a display device; calibrating first correction data with respect to a non-uniformity of a brightness of the measuring device based on the measurement data; and calibrating second correction data for each of the plurality of display modules with respect to a non-uniformity of the brightness of each of the plurality of display modules included in the display device, based on the measurement data and the first correction data.

The control method may further include transmitting the second correction data to each of the plurality of display modules included in the display device such that the second correction data is applied to each of the plurality of display modules.

The measurement data may include a plurality of pieces of measurement data for the brightness of each of the plurality of display modules included in the display device, and the calibrating of the first correction data may include calibrating the first correction data based on the plurality of pieces of measurement data.

The calibrating of the first correction data may include calibrating the first correction data based on the measurement data for the brightness of each of the plurality of display modules.

The measuring device may include a plurality of measuring devices, and the calibrating of the first correction data may include calibrating third correction data for each of the plurality of measuring devices with respect to the non-uniformity of the brightness of each of the plurality of measuring devices, based on the measurement data of each of the plurality of measuring devices.

The measurement data may include brightness data for each of at least one color that is displayed by each of the plurality of display modules.

The measurement data may include brightness data for at least one pattern that is displayed by each of the plurality of display modules.

According to yet another aspect of the disclosure, a non-transitory computer-readable recording medium storing one or more programs, the one or more programs including instructions which, when executed by at least one processor of a computer including a server, causes the server to: receive, from a measuring device, measurement data for a brightness of each of a plurality of display modules included in a display device; calibrate first correction data with respect to a non-uniformity of a brightness of the measuring device based on the measurement data; and calibrate second correction data for each of the plurality of display modules with respect to a non-uniformity of the brightness of each of the plurality of display modules included in the display device, based on the measurement data and the first correction data.

The one or more programs may further cause the server to transmit the second correction data to each of the plurality of display modules included in the display device such that the second correction data is applied to each of the plurality of display modules.

The measurement data may include a plurality of pieces of measurement data for the brightness of each of the plurality of display modules included in the display device, and the one or more programs may further cause the server to calibrate the first correction data based on the plurality of pieces of measurement data.

The one or more programs may further cause the server to calibrate the first correction data based on the measurement data for the brightness of each of the plurality of display modules.

The measuring device may include a plurality of measuring devices, and the one or more programs may further cause the server to calibrate third correction data for each of the plurality of measuring devices with respect to the non-uniformity of the brightness of each of the plurality of measuring devices, based on the measurement data of each of the plurality of measuring devices.

The measurement data may include at least one of brightness data for each of at least one color displayed by each of the plurality of display modules or brightness data for at least one pattern displayed by each of the plurality of display modules.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 shows a display device according to one or more embodiments of the disclosure;

FIG. 2 is a perspective view a display module according to one or more embodiments and a display device including the display module;

FIG. 3 shows a pixel arrangement configuring a unit module of a display device according to one or more embodiments;

FIG. 4 is a view describing an error that may be generated according to measurement locations of measuring equipment;

FIG. 5 is a view describing non-uniformity of measured brightness due to an error of measuring equipment;

FIG. 6 is a control block diagram of a server according to one or more embodiments, and a measuring device and a display device that communicate with the server;

FIG. 7 shows mutual operations of a server according to one or more embodiments of the disclosure and a measuring device and a display device that communicate with the server;

FIG. 8 is flowchart of a control method of a server according to one or more embodiments of the disclosure;

FIG. 9 is flowchart of a control method of a server according to one or more embodiments of the disclosure;

FIG. 10 shows a plurality of display modules of a display device according to one or more embodiments of the disclosure;

FIG. 11 is a flowchart illustrating calibrating correction data based on measurement data of a plurality of display modules according to one or more embodiments of the disclosure;

FIG. 12 is a control block diagram showing a server and a plurality of measuring devices according to one or more embodiments of the disclosure; and

FIG. 13 is a flowchart illustrating calibrating correction data based on measurement data of a plurality of measuring devices according to one or more embodiments of the disclosure.

### DETAILED DESCRIPTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “1^{st}”, “2^{nd}”, or “first” or “second” may be used simply to distinguish a component from other components, without limiting the component in other aspects (e.g., importance or order).

A certain (e.g., a first) component is referred to as “coupled” or “connected” with or without the terms “functionally” or “communicatively” to another (e.g., second) component. When mentioned, it means that any of the certain components can be connected to the other component directly (e.g., by wire), wirelessly, or via a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” or “over” another component, it can be directly on the other component or intervening components may also be present.

Hereinafter, one or more embodiments of the disclosure will be described with reference to the accompanying drawings.

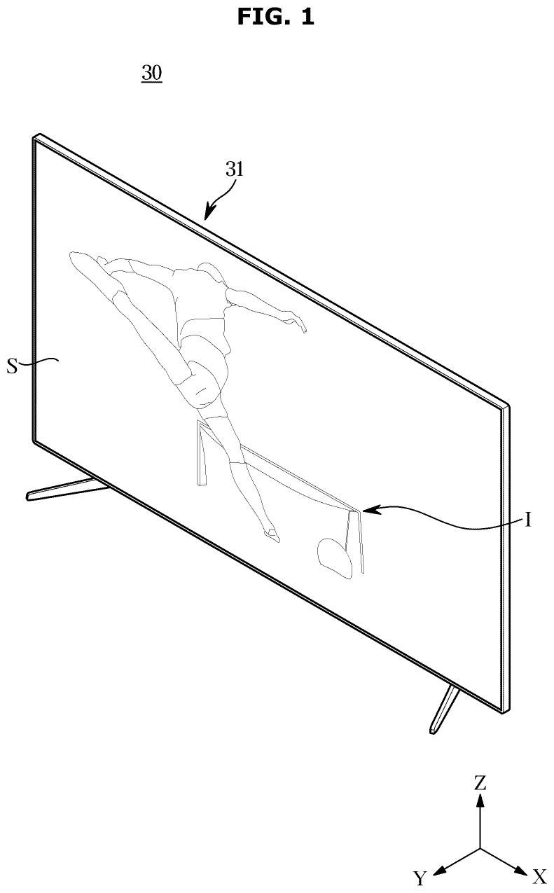

FIG. 1 shows an appearance of a display device according to one or more embodiments of the disclosure.

A display device may be a device capable of processing image signals received from outside and visually displaying the processed signals as images. Hereinafter, a light emitting diode (LED) display will be described as an example of the display device. However, the display device is not limited thereto. For example, the display device may be implemented as various types, such as a television (TV), a LED screen, a display device for indoor, a monitor, a portable multimedia device, a portable communication device, etc. That is, the type of the display device is not limited as long as the display device is capable of visually displaying images.

Also, the display device may be a large display that is installed outdoor, such as the roof of a building or a bus stop, or a display for outdoor. Herein, the outdoor is not necessarily limited to outside, and the display device according to one or more embodiments of the disclosure may be installed at any place where many people come in and out, such as subway stations, shopping malls, movie theaters, places of business, stores, etc., although the place is indoor.

The display device may receive a video signal and an audio signal from various content sources, and output video and audio corresponding to the video signal and audio signal. For example, the display device may receive television broadcasting content from a broadcast receiving antenna or a wired cable, receive content from a content playback device, or receive content from a content provider's content providing server.

The display device may include a self-emissive display panel that displays an image by using self-emissive elements. The self-emissive display panel may include a LED panel. Also, the display device may include a non-emissive display panel that displays an image by transmitting or blocking light emitted form a backlight unit. The non-emissive display panel may include a liquid crystal display (LCD) panel.

As shown in FIG. 1, the display device may include a main body 31 that accommodates a plurality of components for displaying an image I, and a screen S provided on one side of the main body 31 to display an image I.

The main body 31 may form an appearance of the display device and components for enabling the display device to display an image I may be provided inside the main body 31. The main body 31 shown in FIG. 1 may have a flat plate shape. However, the shape of the main body 31 is not limited to the shape shown in FIG. 1. For example, the main body 31 may have a curved shape of which left and right ends protrude forward and of which a center portion is concave.

The screen S may be positioned on a front side of the main body 31, and an image I which is visual information may be displayed on the screen S. For example, a still image or a moving image may be displayed on the screen S, and a 2Dimensional (2D) planar image or a 3Dimensional (3D) stereoscopic image may be displayed on the screen S.

The display device may be implemented as a stand type, as shown in FIG. 1, or as a wall-mount type that is mounted on a wall. Also, the display device may be implemented in a rectangular shape of which a width (length in a X-axis direction) is longer than a height (length in a Z-axis direction) as shown in FIG. 1, in a rectangular shape of which a width is shorter than a height, or in a square shape. There are no restrictions on a supporting method of the display device or the shape of the display device.

In the following embodiments, a direction (+Y direction) in which images are output may be defined as a front direction, and an opposite direction (−Y direction) of the front direction may be defined as a rear direction. A coordinate system of XYZ axes may be based on the display device, and the coordinate system based on the display device does not change even in the case in which the display device lies unlike FIG. 1.

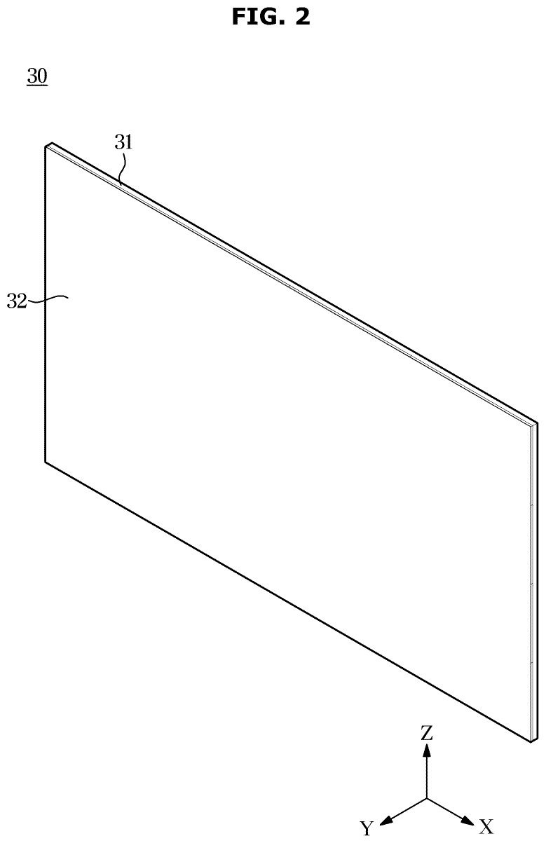

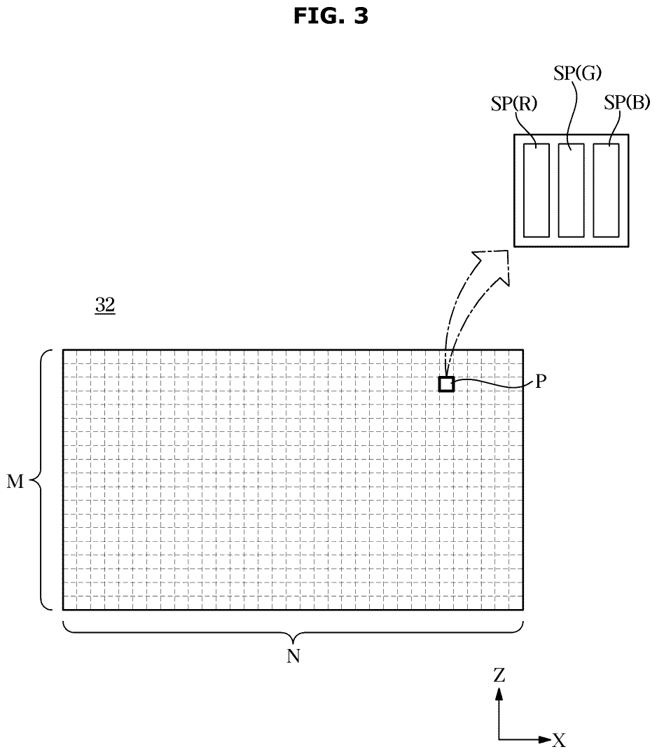

FIG. 2 is a perspective view showing an example of a display module according to one or more embodiments and a display device including the display module, and FIG. 3 shows an example of a pixel arrangement configuring a unit module of a display device according to one or more embodiments.

The display device according to one or more embodiments may be a self-emissive display device in which a light emitting element is positioned for each pixel and thus each pixel itself emits light, or may be a non-emissive display device that displays an image by transmitting or blocking light emitted from a backlight unit.

In the disclosure, the display device will be described under an assumption that the display device is a self-emissive display device. However, the display device according to one or more embodiments is not limited thereto, and may include a non-emissive display device.

Because a self-emissive display device does not require components, such as a backlight unit, a liquid crystal layer, etc., unlike a LCD, the self-emissive display device may implement a small thickness and have a simple structure which allows various design changes.

Also, the display device according to one or more embodiments may adopt an organic light emitting element such as an organic light emitting diode (OLED) as a light emitting element positioned for each pixel. Also, the display device according to one or more embodiments may adopt an inorganic light emitting element such as an inorganic light emitting diode as a light emitting device positioned for each pixel.

The light emitting element adopted in the display device according to one or more embodiments may be a micro LED of which a short side has a length of about 100 μm. As such, by adopting micro-unit LEDs, a pixel size may be reduced and high resolution may be implemented within the same screen size.

In the example of FIG. 2, a case in which a display device 30 includes a single display module 32 is shown. However, the display device 30 may be implemented as a large LED display (large LED screen), a TV, a wearable display, a portable device, a monitor for PC, etc. by including a plurality of display modules to implement a large-area screen.

For convenience of description, a component that constitutes a display device is described as a display module. However, a display device may be configured with a plurality of display devices. That is, a display device may be a modular type, and an element constituting the display device may be expressed by various words, such as a display module, a display device, etc. In the disclosure, such an element is referred to as a display module for convenience.

Referring to FIG. 3, the display module 32 may include a M×N (M and N are integers of two or more) arrangement of pixels, that is, a plurality of pixels arranged two-dimensionally. FIG. 3 conceptually shows an arrangement of pixels. However, the display module 32 may include a wiring area or a bezel area where no image is displayed, in addition to an active area where pixels are arranged.

In the current embodiment, a case in which certain components are arranged two-dimensionally may include, as well as a case in which the corresponding components are arranged on the same plane, a case in which the components are arranged on different planes that are parallel to each other. Also, the case in which the corresponding components are arranged on the same plane may not mean that upper ends of the components necessarily have to be positioned on the same plane, and may include a case in which the upper ends of the components are positioned on different planes that are parallel to each other.

A pixel P may be configured with at least three sub pixels that output different colors of light. For example, a unit pixel P may be configured with three sub pixels of a red sub pixel SP(R), a green sub pixel SP(G), and a blue sub pixel SP(B) respectively corresponding to R, G, and B, wherein the red sub pixel SP(R) may output red light, the green sub pixel SP(G) may output green light, and the blue sub pixel SP(B) may output blue light.

However, the arrangement of pixels of FIG. 3 may be only an example that is applicable to the display module 32 and the display device 30 according to one or more embodiments. The sub pixels may be arranged along an Z-axis direction or may not be aligned. Also, the sub pixels may have different sizes. For a pixel to implement a plurality of colors, the pixel may only need to include a plurality of sub pixels, and there may be no restrictions on sizes or arrangements of the sub pixels.

Also, the pixel P may not be necessarily configured with a red sub pixel SP(R) that outputs red light, a green sub pixel SP(G) that outputs green light, and a blue sub pixel SP(B) that outputs blue light, and the pixel P may include a sub pixel that outputs yellow light or white light. That is, there may be restrictions on colors or kinds of light output from the respective sub pixels or the number of the sub pixels.

However, in the following embodiments, for detailed descriptions, a case in which a pixel P is configured with a red sub pixel SP(R), a green sub pixel SP(G), and a blue sub pixel SP(B) will be described as an example.

As described above, it is assumed that the display module 32 and the display device 30 according to one or more embodiments are self-emissive displays in which each pixel itself emits light. Accordingly, the sub pixels may respectively include light emitting elements that emit different colors of light. For example, a red light emitting element may be positioned in the red sub pixel SP(R), a green light emitting element may be positioned in the green sub pixel SP(G), and a green light emitting element may be positioned in the blue sub pixel SP(B).

Accordingly, in the current embodiment, a pixel P may be a cluster including a red light emitting element, a green light emitting element, and a blue light emitting element, and a sub pixel may be each light emitting element.

Hereinafter, an operation for measuring various data for brightness of the display device 30 and improving brightness non-uniformity of the display device 30 based on a measured value will be described in detail.

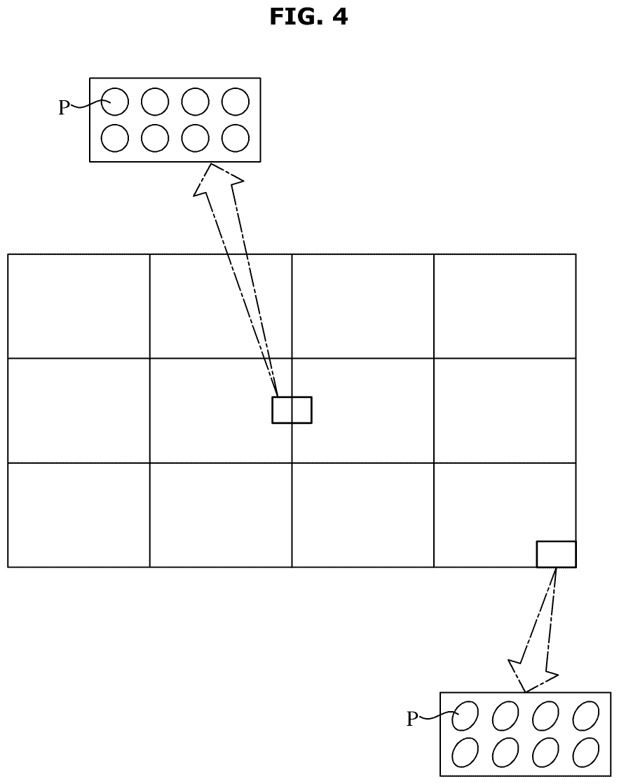

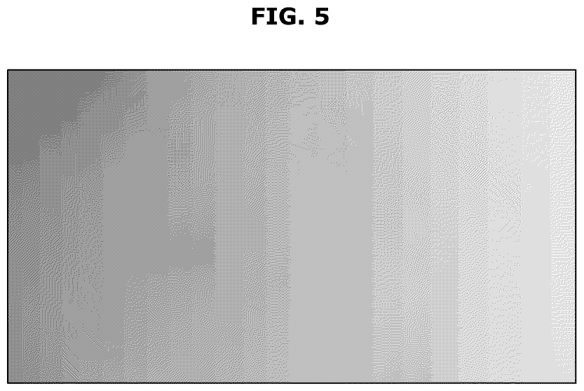

FIG. 4 is a view for describing an error that may be generated according to measurement locations of measuring equipment, and FIG. 5 is a view for describing non-uniformity of measured brightness due to an error of measuring equipment.

In the case of the display device 30 having a brightness non-uniformity characteristic, brightness uniformity may be obtained through correction.

Due to an error of a measuring device 20 for measuring data for brightness of the display device 30, the display device 30 may have non-uniform brightness even after correction.

In the disclosure, to prevent brightness improvement of the display device 30 from deteriorating due to such non-uniformity of measured brightness of the measuring device 20, correction data with respect to non-uniformity of measured brightness of the measuring device 20 may be calibrated based on data measured by the measuring device 20 to remove a cause such as an error, etc. of the measuring device 20, thereby achieving more accurate brightness uniformity of the display device 30.

Referring to FIG. 4, in the case in which the plurality of display modules 32 included in the display device 30 are measured by the measuring device 20, the pixels may have different shapes depending on measuring locations. This means that in the case in which the display modules 32 are measured by the measuring device 20, pixels located at a center area and pixels located at an edge area may have different measured shapes according to lens characteristics of the measuring device 20 even though the pixels are physically the same.

Here, the measuring device 20 may be a separate external device for measuring the plurality of display modules 32 included in the display device 30, and the measuring device 20 may be implemented as various types capable of measuring the plurality of display modules 32 included in the display device 30. For example, the measuring device 20 may be implemented as a measuring instrument, a camera, etc.

As shown in FIG. 4, upon measurement on a center area of the display modules 32, the corresponding pixels may be measured as circles, and upon measurement on an edge area of the display modules 32, the corresponding pixels may be measured as ellipses. That is, the pixels actually having the same shape may be measured as different shapes. Such measurement errors are not limited to those shown in FIG. 4, and various shapes of measurement errors may be generated.

Also, a measurement error may appear in a pixel unit or in another unit. A display device having the same brightness throughout the entire area may be measured to have different brightness according to areas due to a measurement error of a measuring instrument, as shown in FIG. 5. FIG. 5 shows, for convenience of description, an example in which a left area of the plurality of display modules 32 included in the display device 30 is measured to have lower brightness than a right area of the display modules 32. However, the disclosure is not limited thereto, and non-uniformity of measured brightness may be generated in various forms. Also, according to display modules having brightness non-uniformity characteristics, a display device may also have brightness non-uniformity characteristics.

Hereinafter, a server 10 capable of improving brightness non-uniformity of the display device 30 by correcting non-uniformity of measured brightness caused by a measurement error of the measuring device 20, and a control method of the server 10 will be described.

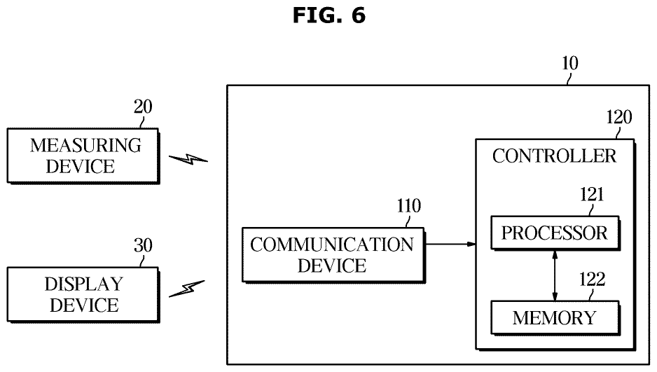

FIG. 6 is a control block diagram showing a server according to one or more embodiments, and a measuring device and a display device that communicate with the server.

The server 10 according to one or more embodiments of the disclosure may include a communication device 110 and a controller 120, and the controller 120 may include at least one processor 121 and a memory 122.

The communication device 110 may communicate with an external device. That is, the communication device 110 according to the disclosure may communicate with the measuring device 20, the display device 30, and the display module 32, and may transmit and/or receive data to and/or from the measuring device 20, the display device 30, and the display module 32.

The measuring device 20 may obtain measurement data for brightness of the plurality of display modules 32 included in the display device 30 and transmit the measurement data for brightness of the plurality of display modules 32 included in the display device 30 to the communication device 110, and the communication device 110 may receive the measurement data for brightness of the plurality of display modules 32 included in the display device 30 from the measuring device 20. Also, the communication device 110 may transmit correction data with respect to brightness non-uniformity of the plurality of display modules 32 included in the display device 30 which will be described below, to the display device 30, and also transmit the correction data to the memory 122.

The controller 120 may include the memory 122 that stores a control program and control data for calibrating correction data, etc. based on various data, and the at least one processor 121 that generates a control signal according to the control program and control data stored in the memory 122. The memory 122 and the processor 122 may be integrated into one body or provided separately.

The memory 122 may store measurement data received by the communication device 110, calibrated correction data, etc. and store a program and data for calibrating correction data, etc. based on various data.

The memory 122 may include a volatile memory for temporarily storing data, such as Static Random Access Memory (SRAM) and Dynamic Random Access Memory (DRAM). Also, the memory 122 may include a non-volatile memory for storing data for a long time, such as Read Only Memory (ROM), Erasable Programmable Read Only Memory (EPROM), and Electrically Erasable Programmable Read Only Memory (EEPROM).

The processor 121 may include various logic circuits and arithmetic circuits, and the processor 121 may process data according to a program provided from the memory 122 and generate a control signal according to the processed result.

The at least one processor 121 may calibrate correction data with respect to non-uniformity of a measured brightness of the measuring device 20 (“first correction data”), based on measurement data for brightness of the plurality of display modules 32 included in the display device 30, received by the communication device 110 and stored in the memory 122.

The at least one processor 121 may calibrate correction data with respect to brightness non-uniformity of each of the plurality of display modules 32 included in the display device 30 (“second correction data”), based on the measurement data for brightness of the plurality of display modules 32 included in the display device 30 and the correction data with respect to the non-uniformity of measured brightness of the measuring device 20. The correction data may be stored in the memory 122.

The communication device 110 may transmit the correction data with respect to the brightness non-uniformity of the plurality of display modules 32 included in the display device 30, calibrated by the at least one processor 121, to the display device 30, and the communication device 110 may transmit the correction data with respect to the brightness non-uniformity of the plurality of display modules 32 included in the display device 30 to the memory 122.

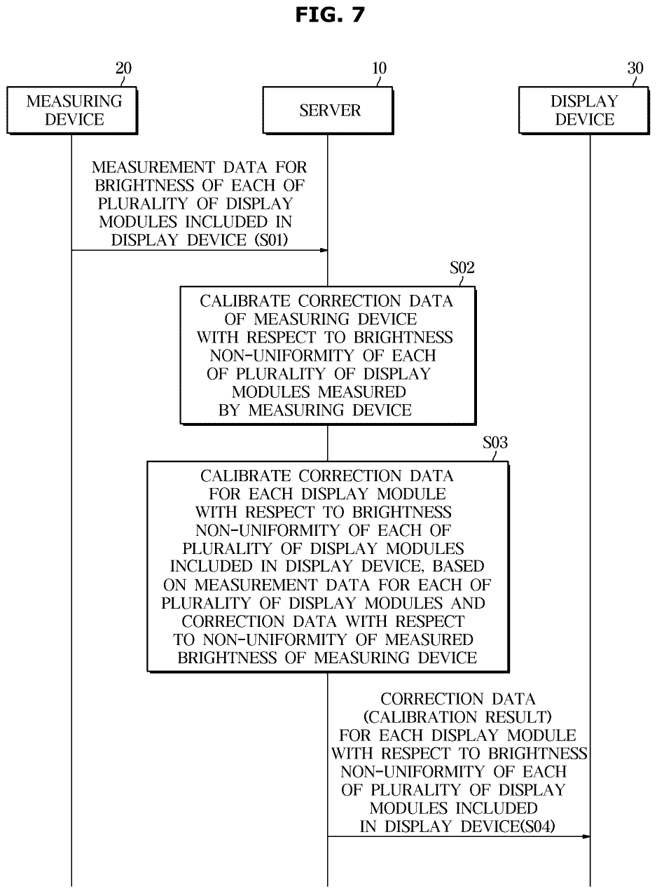

FIG. 7 shows mutual operations of a server according to one or more embodiments of the disclosure, and a measuring device, a display device, and a display module that communicate with the server.

The measuring device 20 may obtain measurement data for brightness of each of the plurality of display modules 32 included in the display device 30, and the server 10 may receive the measurement data through the communication device 110 (S01).

Here, the measurement data for brightness of each of the plurality of display modules 32 included in the display device 30 may include brightness measurement values for various display states of each of the plurality of display modules 32 included in the display device 30.

For example, the measurement data may include a brightness value for at least one color that is expressed by a pixel P in the plurality of display modules 32 included in the display device 30. As described above, according to a pixel P being configured with a red sub pixel S(R), a green sub pixel SP(G), and a blue sub pixel SP(B), a brightness measurement value for each color displayed may be obtained. However, this is only an example, and brightness measurement values for various colors may be obtained.

Also, the measurement data for brightness of the plurality of display modules 32 included in the display device 30 may include brightness measurement values for at least one pattern that is displayed by the plurality of display modules 32 included in the display device 30.

Here, the pattern may be a specific pattern that is displayed by controlling on/off of the pixels P. For example, the pattern may include a pattern that is displayed by turning on all the pixels P.

Also, the measurement data for brightness of the plurality of display modules 32 included in the display device 30 may include brightness measurement values for various gray scales that are displayed by the plurality of display modules 32 included in the display device 30.

The measuring device 20 may obtain various measurement data described above and transmit the various measurement data to the server 10.

Also, the measurement data may include a plurality of pieces of measurement data for brightness of each of the plurality of display modules 32 included in the display device 30. The plurality of pieces of measurement data may include a plurality of pieces of measurement data for various situations described above, or a plurality of pieces of measurement data measured two times or more in the same situation.

The server 10 may receive the measurement data for brightness of each of the plurality of display modules 32 included in the display device 30, from the measuring device 20, and calibrate correction data with respect to non-uniformity of measured brightness of the measuring device 20 based on the measurement data (S02).

The at least one processor 121 may calibrate correction data with respect to non-uniformity of measured brightness of the measuring device 20 based on the plurality of pieces of measurement data for brightness of each of the plurality of display modules 32 included in the display device 30.

That is, the at least one processor 121 may compensate for the non-uniformity of measured brightness of the measuring device 20 based on a common phenomena, etc. in the plurality of pieces of measurement data for brightness of each of the plurality of display modules 32 included in the display device 30.

For example, in the case in which a phenomena in which a left area of the plurality of display modules 32 included in the display device 30, measured by the measuring device 20 is measured to have lower brightness than a right area of the plurality of display modules 32, as shown in FIG. 5, is found commonly in the plurality of pieces of measurement data, the at least one processor 121 may calibrate correction data with respect to such non-uniformity of measured brightness of the measuring device 20.

That is, in a situation as shown in FIG. 5, correction data may be calibrated to make brightness of the left area and brightness of the right area the same such that the same brightness is measured across an entire area.

The server 10 may finally calibrate correction data with respect to non-uniformity of brightness of each of the plurality of display modules 32 included in the display device 30, for each of the plurality of display modules 32, based on the measurement data for brightness of each of the plurality of display modules 32 included in the display device 30, received from the measuring device 20, and the correction data with respect to the non-uniformity of measured brightness of the measuring device 20, calibrated by the at least one processor 121 (S03).

That is, by calibrating correction data with respect to brightness non-uniformity of each of the plurality of display modules 32 included in the display device 30 by using both measurement data for each of the plurality of display modules 32 included in the display device 30 and correction data with respect to non-uniformity of measured brightness of the measuring device 20 in consideration of an error, etc. of the measuring device 20, instead of using only the measurement data for each of the plurality of display modules 32 included in the display device 30, brightness non-uniformity of each of the plurality of display modules 32 included in the display device 30 may be further improved.

The server 10 may store, as a calibration result, the calibrated correction data of each of the plurality of display modules 32 with respect to the non-uniformity of brightness of each of the plurality of display modules 32 included in the display device 30, in the memory 122, and transfer the correction data to each of the plurality of display modules 32 through the communication device 110 such that the correction data is applied to each of the plurality of display modules 32. Also, in the case in which the display module 32 is not used alone and the plurality of display modules 32 constitutes the display device 30, the server 10 may transfer corresponding correction data to each of the display modules 32 such that the correction data is applied to the display module 32 (S04).

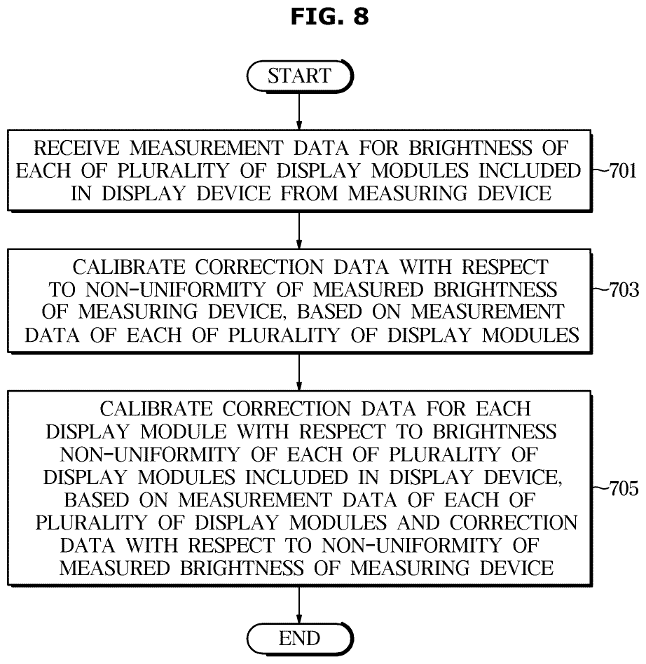

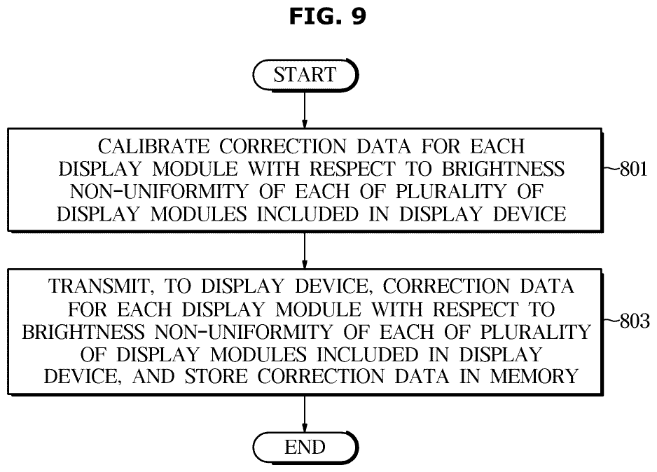

FIGS. 8 and 9 are flowcharts showing a control method of a server according to one or more embodiments of the disclosure.

The server 10 may receive measurement data for brightness of each of the plurality of display modules 32 included in the display device 30 from the measuring device 20 through the communication device 110 (701).

As described above, the measurement data may include various measurement data for brightness of each of the plurality of display modules 32 included in the display device 30. For example, the measurement data may include brightness data for each of at least one color that is displayed by each of the plurality of display modules 32 included in the display device 30, or brightness data for at least one pattern that is displayed by each of the plurality of display modules included in the display device 30.

The at least one processor 121 may calibrate correction data with respect to non-uniformity of measured brightness of the measuring device 20, based on the measurement data (“first correction data”) (703).

Correction data for correcting such brightness non-uniformity may be calibrated based on a common brightness non-uniformity phenomena determined by a plurality of pieces of measurement data.

The at least one processor 121 may calibrate correction data for each display module 32 with respect to brightness non-uniformity of each of the plurality of display modules 32 included in the display device 20 (“second correction data”), based on the measurement data for brightness of each of the plurality of display modules 32 included in the display device 30 and the correction data with respect to the non-uniformity of measured brightness of the measuring device 20 (705).

The communication device 110 may transmit the calibrated correction data with respect to the brightness non-uniformity of each of the plurality of display modules 32 included in the display device 30 (801) to the display device 30 (803), and store the correction data in the memory 122. Each of the plurality of display modules 32 included in the display device 30 may be corrected to have a uniform brightness characteristic by reflecting the received correction data (calibration result) for each display module 32, and the display device 30 configured as a combination of the display modules 32 may also be corrected to have a uniform brightness characteristic.

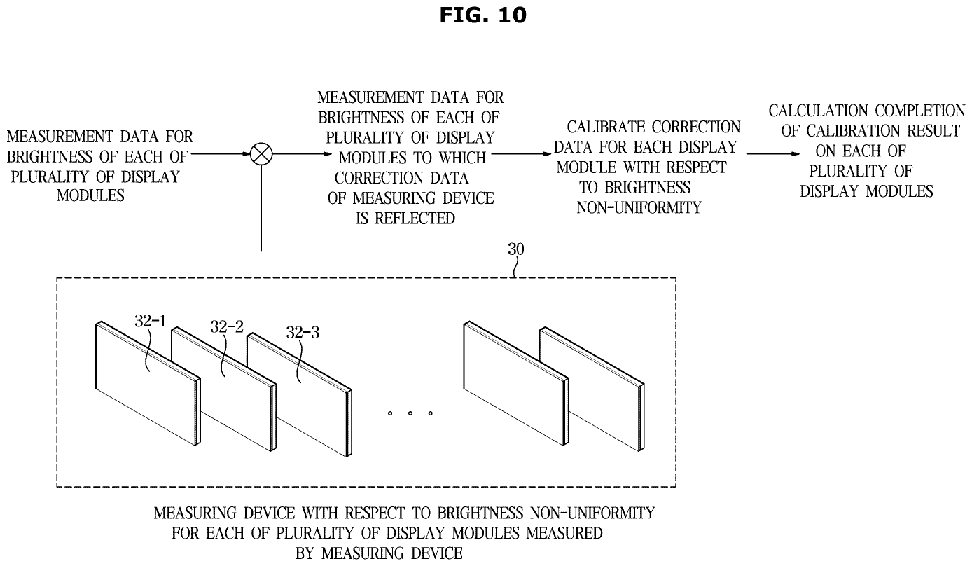

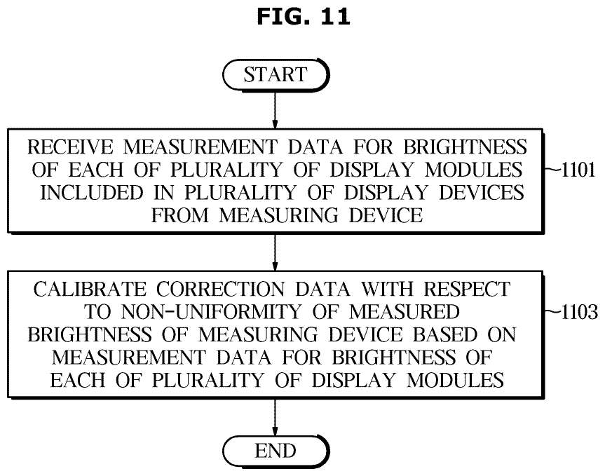

FIG. 10 shows a plurality of display modules of a display device according to one or more embodiments of the disclosure, and FIG. 11 is a flowchart illustrating calibrating correction data with respect to non-uniformity of measured brightness of a measuring device based on measurement data of a plurality of display modules according to one or more embodiments of the disclosure.

Referring to FIG. 10, the display device 30 may include a plurality of display modules 32-1, 32-2, 32-3, . . . . That is, the display device 30 according to one or more embodiments may be a display device 30 consisting of a single module or a modular display device 30 configured by assembling a plurality of modules. Although elements constituting a display device are referred to as display modules, the term is an expression used for explanation purposes and such elements are not limited to the term modules. Accordingly, a display device may be configured as a single display or as a combination of several displays.

Such as, in the case in which the display device 30 is configured with a plurality of display modules, the measuring device 20 may measure brightness for each of the display modules.

The communication device 110 may receive measurement data for brightness of each of the plurality of display modules 32 from the measuring device 20 (1101), and the at least one processor 121 may generate measurement data for brightness of each of the plurality of display modules 32 to which correction data of the measuring device 20 is reflected. Thereafter, the at least one processor 121 may calibrate correction data with respect to non-uniformity of measured brightness of the measuring device 20 based on the measurement data for brightness of each of the plurality of display modules 32 (1103).

That is, by determining a measurement error, etc. of the measuring device 20 based on measurement data for each of the display modules 32, correction data for each display module 32 based on measurement data for each display module 32 may be calibrated.

The at least one processor 121 may calibrate correction data with respect to brightness non-uniformity of the display device 30, based on the measurement data for brightness of each of the plurality of display modules 32 and the correction data with respect to the brightness non-uniformity of the measuring device 20 based on the measurement data for each display module 32.

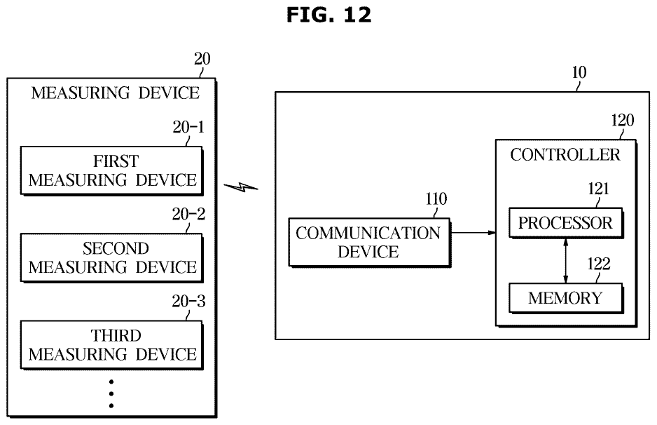

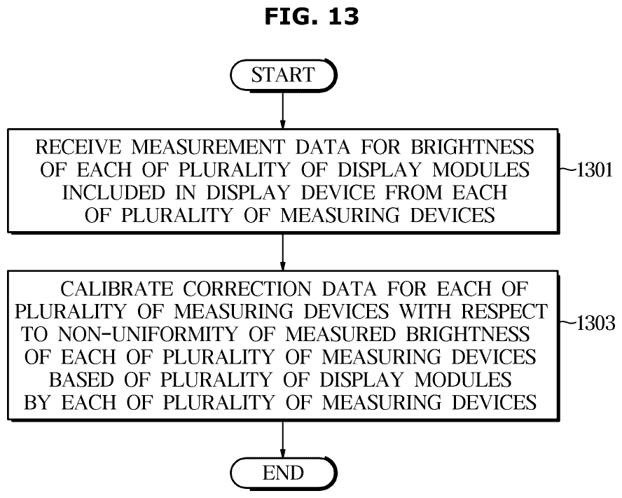

FIG. 12 is a control block diagram showing a server and a plurality of measuring devices according to one or more embodiments of the disclosure, and FIG. 13 is a flowchart illustrating calibrating correction data for each of a plurality of measuring devices according to one or more embodiments of the disclosure based on measurement data of the plurality of measuring devices.

Measurement data for brightness of each of the plurality of display modules 32 included in the display device 30 may be obtained by a single measuring device 20 or two or more measuring devices 20. That is, as shown in FIG. 12, the measuring device 20 may include a plurality of measuring devices 20-1, 20-2, 20-3, . . . , including a first measuring device 20-1 to a third measuring device 30-2.

In the case in which there are a plurality of measuring devices 20, each of the measuring devices 20 may obtain measurement data for brightness of each of the plurality of display modules 32 included in the display device 30, and the communication device 110 may receive the measurement data for brightness of each of the plurality of display modules 32 included in the display device 30 from each of the plurality of measuring devices 20 (1301).

The at least one processor 121 may calibrate correction data for each of the plurality of measuring devices 20 with respect to non-uniformity of measured brightness of each of the plurality of measuring devices 20 (“third correction data”), based on the measurement data for brightness of each of the plurality of display modules 32, obtained by each of the plurality of measuring devices 20 (1303).

The at least one processor 121 may calibrate correction data for each of the plurality of measuring devices 20 with respect to brightness non-uniformity of each of the plurality of display modules 32 included in the display device 30, based on the measurement data for brightness of each of the plurality of display modules 32, obtained by each of the plurality of measuring devices 20, and the correction data for each of the plurality of measuring devices 20 with respect to the non-uniformity of measured brightness of each of the plurality of measuring devices 20.

In the case in which different measuring devices are applied to a plurality of same display modules, correction data with respect to non-uniformity characteristics of measured brightness of the respective measuring devices may be different from each other. As a result, different correction data may need to be respectively applied to the plurality of display modules.

According to one or more embodiments, a server may include: a communication device configured to receive, from a measuring device, measurement data for a brightness of each of a plurality of display modules included in a display device; a memory storing the measurement data; and at least one processor configured to: calibrate first correction data with respect to a non-uniformity of a brightness of the measuring device based on the measurement data; and calibrate second correction data for each of the plurality of display modules with respect to a non-uniformity of the brightness of each of the plurality of display modules, based on the measurement data and the first correction data.

According to one or more embodiments, the communication device may be configured to transmit the second correction data to each of the plurality of display modules such that the second correction data is applied to each of the plurality of display modules.

According to one or more embodiments, the measurement data may include a plurality of pieces of measurement data for the brightness of each of the plurality of display modules included in the display device, and the at least one processor may be further configured to calibrate the first correction data based on the plurality of pieces of measurement data.

According to one or more embodiments, the at least one processor may be further configured to calibrate the first correction data based on the measurement data for the brightness of each of the plurality of display modules.

According to one or more embodiments, the measuring device may include a plurality of measuring devices, and the at least one processor may be further configured to calibrate third correction data for each of the plurality of measuring devices with respect to the non-uniformity of the brightness of each of the plurality of measuring devices, based on the measurement data of each of the plurality of measuring devices.

According to one or more embodiments, the measurement data may include brightness data for each of at least one color displayed by each of the plurality of display modules.

According to one or more embodiments, the measurement data may include brightness data for at least one pattern displayed by each of the plurality of display modules.

According to one or more embodiments, a control method of a server includes: receiving, from a measuring device, measurement data for a brightness of each of a plurality of display modules included in a display device; calibrating first correction data with respect to a non-uniformity of a brightness of the measuring device based on the measurement data; and calibrating second correction data for each of the plurality of display modules with respect to a non-uniformity of the brightness of each of the plurality of display modules included in the display device, based on the measurement data and the first correction data.

According to one or more embodiments, the control method may further include transmitting the second correction data to each of the plurality of display modules included in the display device such that the second correction data is applied to each of the plurality of display modules.

According to one or more embodiments, the measurement data may include a plurality of pieces of measurement data for the brightness of each of the plurality of display modules included in the display device, and the calibrating of the first correction data may include calibrating the first correction data based on the plurality of pieces of measurement data.

According to one or more embodiments, the calibrating of the first correction data may include calibrating the first correction data based on the measurement data for the brightness of each of the plurality of display modules.

According to one or more embodiments, the measuring device may include a plurality of measuring devices, and the calibrating of the first correction data may include calibrating third correction data for each of the plurality of measuring devices with respect to the non-uniformity of the brightness of each of the plurality of measuring devices, based on the measurement data of each of the plurality of measuring devices.

According to one or more embodiments, the measurement data may include brightness data for each of at least one color that is displayed by each of the plurality of display modules.

According to one or more embodiments, the measurement data may include brightness data for at least one pattern that is displayed by each of the plurality of display modules.

According to one or more embodiments, a non-transitory computer-readable recording medium storing one or more programs, the one or more programs including instructions which, when executed by at least one processor of a computer including a server, causes the server to: receive, from a measuring device, measurement data for a brightness of each of a plurality of display modules included in a display device; calibrate first correction data with respect to a non-uniformity of a brightness of the measuring device based on the measurement data; and calibrate second correction data for each of the plurality of display modules with respect to a non-uniformity of the brightness of each of the plurality of display modules included in the display device, based on the measurement data and the first correction data.

According to one or more embodiments, the one or more programs may further cause the server to transmit the second correction data to each of the plurality of display modules included in the display device such that the second correction data is applied to each of the plurality of display modules.

According to one or more embodiments, the measurement data may include a plurality of pieces of measurement data for the brightness of each of the plurality of display modules included in the display device, and the one or more programs may further cause the server to calibrate the first correction data based on the plurality of pieces of measurement data.

According to one or more embodiments, the one or more programs may further cause the server to calibrate the first correction data based on the measurement data for the brightness of each of the plurality of display modules.

According to one or more embodiments, the measuring device may include a plurality of measuring devices, and the one or more programs may further cause the server to calibrate third correction data for each of the plurality of measuring devices with respect to the non-uniformity of the brightness of each of the plurality of measuring devices, based on the measurement data of each of the plurality of measuring devices.

According to one or more embodiments, the measurement data may include at least one of brightness data for each of at least one color displayed by each of the plurality of display modules or brightness data for at least one pattern displayed by each of the plurality of display modules.

The non-transitory computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

While the disclosure has been illustrated and described with reference to one or more embodiments, it will be understood that the one or more embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiments described herein may be used in conjunction with any other embodiments described herein.

What is claimed is:

1. A server comprising:
a communication device configured to receive, from a measuring device, measurement data for a brightness of each of a plurality of display modules included in a display device;
a memory storing the measurement data; and
at least one processor configured to:
calibrate first correction data with respect to a non-uniformity of a brightness of the measuring device based on the measurement data; and
calibrate second correction data for each of the plurality of display modules with respect to a non-uniformity of the brightness of each of the plurality of display modules, based on the measurement data and the first correction data.

2. The server of claim 1, wherein the communication device is configured to transmit the second correction data to each of the plurality of display modules such that the second correction data is applied to each of the plurality of display modules.

3. The server of claim 1, wherein the measurement data comprises a plurality of pieces of measurement data for the brightness of each of the plurality of display modules included in the display device, and
wherein the at least one processor is further configured to calibrate the first correction data based on the plurality of pieces of measurement data.

4. The server of claim 1, wherein the at least one processor is further configured to calibrate the first correction data based on the measurement data for the brightness of each of the plurality of display modules.

5. The server of claim 1, wherein the measuring device comprises a plurality of measuring devices, and
wherein the at least one processor is further configured to calibrate third correction data for each of the plurality of measuring devices with respect to the non-uniformity of the brightness of each of the plurality of measuring devices, based on the measurement data of each of the plurality of measuring devices.

6. The server of claim 1, wherein the measurement data comprises brightness data for each of at least one color displayed by each of the plurality of display modules.

7. The server of claim 1, wherein the measurement data comprises brightness data for at least one pattern displayed by each of the plurality of display modules.

8. A control method of a server, comprising:
receiving, from a measuring device, measurement data for a brightness of each of a plurality of display modules included in a display device;
calibrating first correction data with respect to a non-uniformity of a brightness of the measuring device based on the measurement data; and
calibrating second correction data for each of the plurality of display modules with respect to a non-uniformity of the brightness of each of the plurality of display modules included in the display device, based on the measurement data and the first correction data.

9. The control method of claim 8, further comprising transmitting the second correction data to each of the plurality of display modules included in the display device such that the second correction data is applied to each of the plurality of display modules.

10. The control method of claim 8, wherein the measurement data comprises a plurality of pieces of measurement data for the brightness of each of the plurality of display modules included in the display device, and
wherein the calibrating of the first correction data comprises calibrating the first correction data based on the plurality of pieces of measurement data.

11. The control method of claim 10, wherein the calibrating of the first correction data comprises calibrating the first correction data based on the measurement data for the brightness of each of the plurality of display modules.

12. The control method of claim 10, wherein the measuring device comprises a plurality of measuring devices, and
wherein the calibrating of the first correction data comprises calibrating third correction data for each of the plurality of measuring devices with respect to the non-uniformity of the brightness of each of the plurality of measuring devices, based on the measurement data of each of the plurality of measuring devices.

13. The control method of claim 8, wherein the measurement data comprises brightness data for each of at least one color that is displayed by each of the plurality of display modules.

14. The control method of claim 8, wherein the measurement data comprises brightness data for at least one pattern that is displayed by each of the plurality of display modules.

15. A non-transitory computer-readable recording medium storing one or more programs, the one or more programs comprising instructions which, when executed by at least one processor of a computer comprising a server, cause the server to:
receive, from a measuring device, measurement data for a brightness of each of a plurality of display modules included in a display device;
calibrate first correction data with respect to a non-uniformity of a brightness of the measuring device based on the measurement data; and
calibrate second correction data for each of the plurality of display modules with respect to a non-uniformity of the brightness of each of the plurality of display modules included in the display device, based on the measurement data and the first correction data.

16. The non-transitory computer-readable recording medium of claim 15, wherein the one or more programs further cause the server to transmit the second correction data to each of the plurality of display modules included in the display device such that the second correction data is applied to each of the plurality of display modules.

17. The non-transitory computer-readable recording medium of claim 15, wherein the measurement data comprises a plurality of pieces of measurement data for the brightness of each of the plurality of display modules included in the display device, and
wherein the one or more programs further cause the server to calibrate the first correction data based on the plurality of pieces of measurement data.

18. The non-transitory computer-readable recording medium of claim 15, wherein the one or more programs further cause the server to calibrate the first correction data based on the measurement data for the brightness of each of the plurality of display modules.

19. The non-transitory computer-readable recording medium of claim 15, wherein the measuring device comprises a plurality of measuring devices, and
wherein the one or more programs further cause the server to calibrate third correction data for each of the plurality of measuring devices with respect to the non-uniformity of the brightness of each of the plurality of measuring devices, based on the measurement data of each of the plurality of measuring devices.

20. The non-transitory computer-readable recording medium of claim 15, wherein the measurement data comprises at least one of brightness data for each of at least one color displayed by each of the plurality of display modules or brightness data for at least one pattern displayed by each of the plurality of display modules.
